(19) United States
(12) Patent Application Publication
(10) Pub. No.: US 2004/0104560 A1
(43) Pub. Date: Jun. 3, 2004

(54) Cart with seat

(76) Inventor: Thomas L. Tedesco, Los Angeles, CA (US)

Correspondence Address: JAMES BAME, 6419 SEABRYN DRIVE, RANCHO PALOS VERDES, CA, 90275, US

(21) Appl. No.: 10/307,554

(22) Filed: Dec. 2, 2002

(51) Int. Cl. B62B 1/00

(52) U.S. Cl. 280/651; 280/47.29

(57) ABSTRACT

A foldable cart with seat includes a base having a plurality of rotating mechanisms and a roller. The roller includes two wheels positioned adjacent to the base. An extendable back frame is attached to one or more of the rotating mechanisms. The seat is attachable to the back frame. The cart with seat has a folded position for ease of storage, a cart position for transporting articles, and a seat position for sitting. The seat position is adjustable to a piano bench height and a bar stool height.

### BACKGROUND

The field of invention relates to portable carriers that are collapsible. More particularly, the field of invention involves a portable carrier for transporting personal items, which also converts to other useful functions.

Musicians often perform at social events, nightclubs and piano bars where they must transport their own musical instruments. Therefore, the musician has a need for a carrier cart that will haul the musical instruments and associated accessories. Musicians often transport their own instruments and amplifiers to the performance. The amplifiers can be quite heavy and bulky. A strong and rugged carrier cart is needed to transport all the necessary articles required for the musical presentation.

Additionally, the musician often transports their own stool for sitting. The musician will often have a favorite stool, which is the proper height for their comfort and ease in playing the instrument. Stools or seats may be an inconvenient height and uncomfortable, when they are provided by the facility. Thus, the musician has a preference for bringing their own personal article for sitting.

There are other activities where it would be advantageous to have a carrier cart and a stool or chair for sitting. For example, outdoor sporting events and concerts, where bleachers are not provided or available seating is already fully occupied. Airport terminals often require long waiting periods

Hence, two items are often necessary, first a cart for hauling items and secondly, a stool for sitting. It would be advantageous if the two items could be combined into one. The seat should be adjustable to different heights to accommodate the preference of various users.

There are numerous prior art devices available that are collapsible carriers for boxes, luggage or other items. For example, U.S. patent application Ser. No. 20020041084, by Charles Darling discloses a multi-purpose, collapsible portable cart for use in camping, hunting and other outdoor activities. The portable cart can carry a canoe, small game or other cargo. The portable cart can be folded down and carried within a backpack.

U.S. patent application Ser. No. 20020043544 by Mary Ann Caneba discloses a pack carrier on wheels that includes a quasi-permanent height-adjustable handle and a concealable seat. The pack carrier is connectable to a bike or scooter. The pack carrier is not designed to be collapsible.

Therefore, there is a need for a carrier cart that is combined with a seat. The cart should be collapsible and the seat should be adjustable.

### SUMMARY

An objective of the foldable cart with seat is providing a dual purpose cart, which will function both as a carrier for transporting items and as a stool for sitting. Musicians must often have two devices, their cart for transporting musical instruments and also carry a stool for sitting. A dual purpose cart would provide significant benefit. Musical instruments can sometime be large, so it is important to have a carrier cart for transport. Guitarist, bass players, and wind instrument musicians, all usually transport their own instruments and amplifiers to a performance or rehearsal.

Another objective of the foldable cart with seat is providing a cart that is collapsible for easy storage. The cart is often carried in an automobile trunk, where compact size is important. Musical instruments can sometime be delicate, along with being large. Thus maximizing the storage room for the musical instrument and minimizing the required space for the cart has advantages.

Another objective of the foldable cart with seat is providing a stand that will support an acoustic amplifier, during the musicians performance.

Another objective of the foldable cart is providing a stool for sitting that has an adjustable seat height. Different individuals prefer a different height seat when they are giving a performance. Furthermore, different instruments are best played from different sitting positions. An adjustable height stool will provide greater comfort and improve the performance of the musician.

A foldable cart with seat includes a base having a plurality of rotating mechanisms and a roller. The roller includes two wheels positioned adjacent to the base. An extendable back frame is attached to one or more of the rotating mechanisms. The seat is attachable to the back frame. The cart with seat has a folded position for ease of storage, a cart position for transporting articles, and a seat position for sitting. The seat is rotatably attached to the back frame. A front frame is attached to the base by one or more rotating mechanisms.

The back frame has an upper section and a lower section. The upper section recedes within and is substantially accepted by the lower section. Alternately, the upper section is extendable beyond the lower section to create the different heights for the seat. The seat is removably attached to the back frame and the front frame, when the cart with seat is assembled in the seat position. A handle is rotatably attached to the back frame. The handle is detachable and collapsible for ease of storage and transportation. The handle is convenient for pulling the cart, when the cart is transporting articles.

The first rotating mechanism has a cam lock attached to the back frame and a back release bar attached to the base. The cam lock has folded position slot and an open position slot. The release bar engages the folded position slot and the open position slot.

The front frame has a top portion with a downwardly extending first vertical member and a downwardly extending second vertical member. The front frame has a lower portion with a first vertical channel and a second vertical channel. The first vertical channel accepts the first vertical member and the second vertical channel accepts the second vertical member. This allows the top portion to collapse into the bottom portion. The bottom portion substantially accepts the top portion, when the cart is collapsed and folded. The top portion is extendable beyond the bottom portion to create the various position heights.

The top portion of the front frame has a first horizontal member connected between the first vertical channel and the second vertical channel. The first vertical member has a first plurality of apertures and the second vertical member has a second plurality of apertures. The first horizontal member has a trigger latch with a first projection and a second projection. The first projection removably engages the first plurality of apertures and the second projection removably engages the second plurality of apertures, such that the seat is adjustable to two or more varying heights. In a preferred embodiment there is a piano bench height and a bar stool height.

The apertures are separated by a distance of between about two and three-quarters of an inches and about two and three-quarters of an inches. The piano bench height is between about 17 inches and about 19 inches. The bar stool height is between about 25 inches and about 26 inches. In a preferred embodiment the piano bench height is about 18 inches and the bar stool height is about 25½. A seat cushion can be added, which adds about 3 inches more to the sitting height. The seat can be fully removed from the base for ease of storage and transportation. Alternately, the seat is left attached to the base after being collapsed for storage.

Although the present invention is briefly summarized, a fuller understanding of the invention can be obtained from the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a side perspective view.

FIG. 2a is a side perspective view of the cart position.

FIG. 2b is a front view.

FIG. 2c is a side view.

FIG. 3a is a side perspective view of the seated position

FIG. 3b is a front view.

FIG. 3c is a side view.

FIG. 4a is a side perspective view of the storage position.

FIG. 4b is a front view.

FIG. 4c is a side view.

FIG. 4d is a top view.

### DETAILED DESCRIPTION OF THE PREFERRED EMBODIMENTS

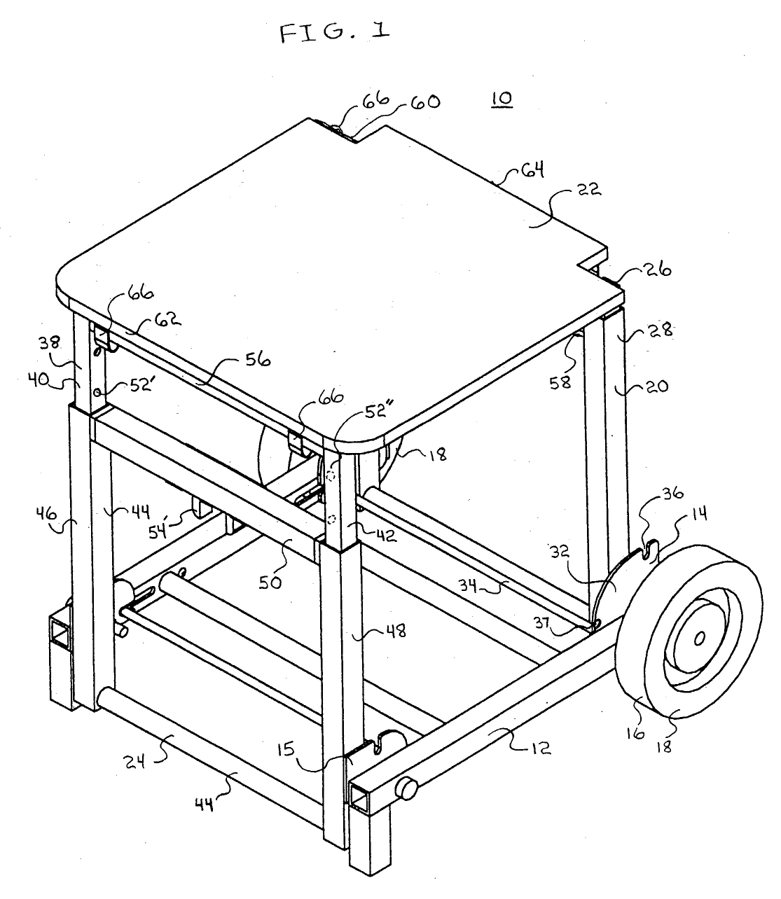

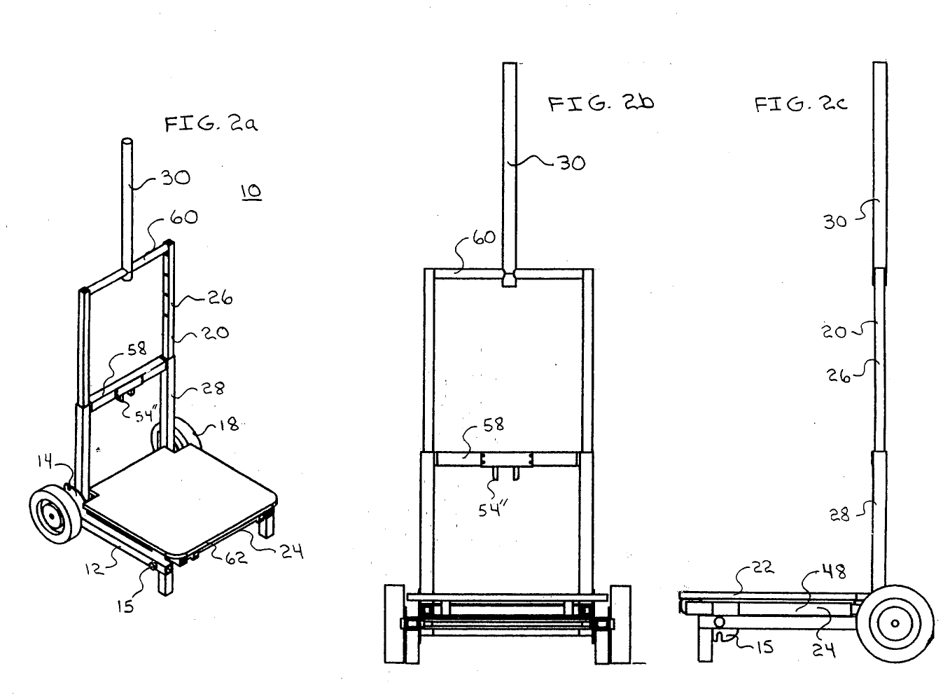

Referring to FIGS. 1, 2a, 2b, 2c a foldable cart with seat 10 includes a base 12 having a plurality of rotating mechanisms 14, 15 and a roller 16. The plurality of rotating mechanisms includes a first rotating mechanism 14 and a second rotating mechanism 15. The roller 16 includes two wheels 18 positioned adjacent to the base 12. An extendable back frame 20 is attached to one or more of the rotating mechanisms 14, 15. The seat 22 is attachable to the back frame 20. The cart with seat 10 has a folded position for ease of storage, a cart position for transporting articles, and a seat position for sitting. The seat 22 is rotatably attached to the back frame 20. A front frame 24 is attached to the base 12 by one or more rotating mechanisms.

The back frame 20 has an upper section 26 and a lower section 28. The upper section 26 recedes within and is substantially accepted by the lower section 28, as shown in FIG. 1. Alternately, the upper section 26 is extendable beyond the lower section 28, as shown in FIG. 2a. The seat 22 is removably attached to the back frame 20 and/or the front frame 24. Extending the front frame 24 and extending the upper section 26 of the back frame 20 and attaching the seat 22 creates the different heights for the seat 22.

A handle 30 is rotatably attached to the back frame 20. The handle 30 is detachable and collapsible for ease of storage or for placement within the trunk of a vehicle. The handle 30 easily reassembles and is convenient for pulling the cart, when the cart is transporting articles.

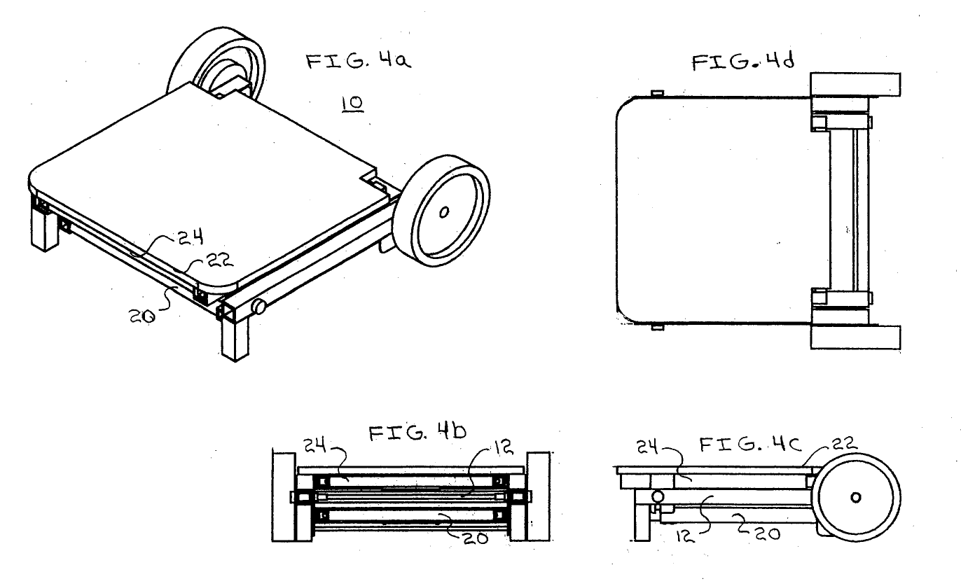

The back frame 20 has a first rotating mechanism 14 that allows the back frame 20 to move between a folded position and the cart or seated positions. A second rotating mechanism 15 is attached to the front frame 24, which similarly allows the front frame 24 to move between the folded position and the cart or seated positions. The seated position is illustrated in FIG. 1. The cart position for transporting articles is illustrated in FIG. 2a. The folded position is illustrated in FIG. 4a.

The first rotating mechanism 14 has a cam lock 32 attached to the back frame 20 and a back release bar 34 attached to the base 12. The cam lock 32 has a folded position slot 36 and an open position slot 37. The release bar 34 engages the folded position slot 36 and the open position slot 37. The open position slot 37 accepts the back release bar 34 in the seated and cart positions.

The front frame 24 has a top portion 38 with a downwardly extending first vertical member 40 and a downwardly extending second vertical member 42. The front frame 24 has a bottom portion 44 with a first vertical channel 46 and a second vertical channel 48. The first vertical channel 46 accepts the first vertical member 40 and the second vertical channel 48 accepts the second vertical member 42. This allows the top portion 38 to collapse into the bottom portion. The bottom portion substantially accepts the top portion 38, when the cart is collapsed in the folded position. The top portion 38 is extendable beyond the bottom portion to create the various position heights.

The top portion 38 of the front frame 24 has a first horizontal member 50 connected between the first vertical channel 46 and the second vertical channel 48. The first vertical member 40 has a first plurality of apertures 52′ and the second vertical member 42 has a second plurality of apertures 52″. The first horizontal member 50 has a trigger latch 54′ with a first projection and a second projection (not shown). The first projection removably engages the first plurality of apertures 52′ and the second projection removably engages the second plurality of apertures 52″, such that the seat 22 is adjustable to two or more varying heights. In a preferred embodiment there is a piano bench height and a bar stool height.

The apertures 52′, 52″ are separated by a distance of between about two and three-quarters inches and about two and one-half inches. The piano bench height is between about 17 inches and about 19 inches. The bar stool height is between about 25 inches and about 26 inches. In a preferred embodiment the piano bench height is about 18 inches and the bar stool height is about twenty-five and one-half inches (25½″). A seat cushion can be added, which adds about 3 inches more to the sitting height.

The front frame 24 has a third horizontal member 56. FIG. 2a illustrates the back frame 20 with a second horizontal member 58 and a fourth horizontal member 60. The seat 22 has a forward edge 62 and a rear edge 64. The seat 22 has a plurality of clips 66 positioned along the forward edge 62 and the rear edge 64. In FIG. 1, some of the plurality of clips 66 are attached around the third horizontal member 56 and the remainder of the plurality of clips 66 are attached to the fourth horizontal member 60. When assembled, the forward edge 62 of the seat 22 is removably attached to the third horizontal member 56 and the rear edge 64 is removably attached to the fourth horizontal member 60. The seat 22 can be fully removed from the base 12 for ease of storage and transportation. Alternately, the seat 22 is left attached to the base 12, front frame 24 or back frame 20 after being collapsed for storage and transporting.

Referring particularly to FIGS. 2a, 2b, and 2c, the cart with seat 10 is shown in the cart position. The front frame 24 is rotated via the second rotating mechanism 15 and collapsed adjacent to the base 12. The back frame 20 is locked into an upright state by the first rotating mechanism 14. The upper section 26 is extended from the lower section 28, similar to the procedure used to collapse and extend the bottom portion and top portion 38 of the front frame 24. The seat 22 is positioned low, near the wheels 18, for transporting articles.

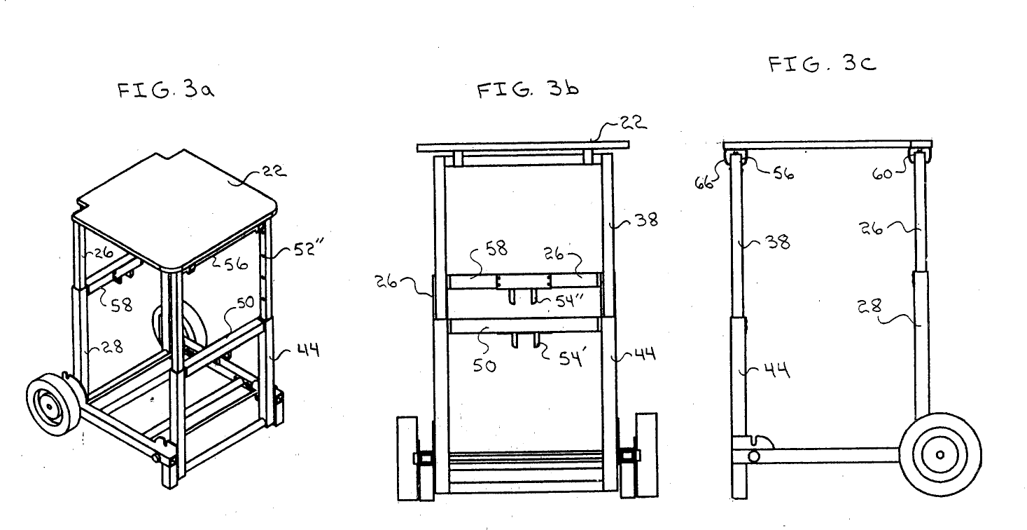

FIGS. 3a, 3b, and 3c illustrate the bar stool height, which is between about 25 inches and about 26 inches. The seat 22 is attached to the third horizontal member 56 and to the fourth horizontal member 60. The first horizontal member 50 has a trigger latch 54′ which is squeezed to withdraw the first projection and a second projection from the apertures 52′, 52″. The top portion 38 can then be extended from the bottom portion 44 to various heights. The second horizontal member 58 has a trigger latch 54″ that operates in a similar manner, which allows the upper section 26 to extend from the lower section 28.

Referring to FIGS. 4a, 4b, 4c, and 4d; the cart with seat 10 is fully collapsed in the folded position. The back frame 20 and front frame 24 are rotated to a position approximately parallel to the ground directly adjacent to the base 12. The seat 22 is attached to the front frame 24. The folded position allows for easy storage or transportation in a vehicle.

Although the present invention has been described in considerable detail with regard to the preferred versions thereof, other versions are possible. Therefore, the appended claims should not be limited to the descriptions of the preferred versions contained herein.

What is claimed is:

1. A cart with seat comprising:
a) a base having a plurality of rotating mechanisms and a roller;
b) an extendable back frame attached to one or more rotating mechanisms; and
c) a seat attachable to the back frame;
wherein the cart with seat having a folded position for ease of storage, wherein the cart with seat having a cart position for transporting articles, and wherein the cart with seat having a seat position for sitting.

2. The cart with seat of claim 1, wherein the seat is rotatably attachable to the back frame.

3. The cart with seat of claim 2, further comprising a front frame attached to one or more rotating mechanisms.

4. The cart with seat of claim 3, wherein the front frame having a top portion with a downwardly extending first vertical member and a downwardly extending second vertical member, wherein the front frame having a bottom portion with a first vertical channel and a second vertical channel, wherein the first vertical channel accepts the first vertical member and the second vertical channel accepts the second vertical member, such that the top portion collapses into and is substantially accepted by the bottom portion and alternately the top portion is extendable beyond the bottom portion.

5. The cart with seat of claim 4, wherein the top portion of the front frame having a first horizontal member connected to the first vertical channel and the second vertical channel, wherein the first vertical member having a first plurality of apertures and the second vertical member having a second plurality of apertures, wherein the first horizontal member having a trigger latch with a first projection and a second projection, wherein the first projection removably engages the first plurality of apertures and the second projection removably engages the second plurality of apertures, such that the seat is adjustable to two or more varying heights, whereby there is a piano bench height and a bar stool height.

6. The cart with seat of claim 5, wherein the piano bench height is between about 17 inches and about 19 inches, and wherein the bar stool height is between about 25 inches and about 26 inches.

7. The cart with seat of claim 6, wherein the back frame having an upper section and a lower section, wherein the upper section recedes within and is substantially accepted by the lower section, and such that alternately the upper section is extendable beyond the lower section.

8. A foldable cart with seat for musicians comprising:
a) a base having a roller;
b) a back frame attached to the base, the back frame having a first rotating mechanism;
c) a front frame attached to the base, the front frame having a second rotating mechanism;
d) a seat; and
e) a handle attached to the back frame; wherein the cart with seat having a folded position for ease of storage, wherein the cart with seat having a cart position for transporting articles, and wherein the cart with seat having a seat position for sitting.

9. The cart with seat of claim 8, wherein the seat is removably attached to the back frame and the front frame, when the cart with seat is assembled in the seat position.

10. The cart with seat of claim 9, wherein the handle is rotatably attached to the back frame.

11. The cart with seat of claim 10, wherein the seat is adjustable to four varying heights.

12. The cart with seat of claim 11, wherein the first rotating mechanism having a cam lock attached to the back frame and a back release bar attached to the base, wherein the cam lock having a folded position slot and an open position slot, wherein the release bar engages the folded position slot and the open position slot.

13. The cart with seat of claim 12, wherein the back frame having an upper section and a lower section, wherein the lower section substantially accepts the upper section, such that the upper section collapses and is substantially accepted by the lower section and such that alternately the upper section is extendable beyond the lower section.

14. The cart with seat of claim 13, wherein the roller comprises: two wheels attached to the base.

15. The cart with seat of claim 14, wherein the front frame having a top portion with a downwardly extending first vertical member and a downwardly extending second vertical member, wherein the front frame having a lower portion with a first vertical channel and a second vertical channel, wherein the first vertical channel accepts the first vertical member and the second vertical channel accepts the second vertical member, such that the top portion collapses into and is substantially accepted by the bottom portion and alternately the top portion is extendable beyond the bottom portion.

16. The cart with seat of claim 15, wherein the top portion of the front frame having a first horizontal member connected to the first vertical channel and the second vertical channel, wherein the first vertical member having a first plurality of apertures and the second vertical member having a second plurality of apertures, wherein the first horizontal member having a trigger latch with a first projection and a second projection, wherein the first projection removably engages the first plurality of apertures and the second projection removably engages the second plurality of apertures, such that the seat is adjustable to two or more varying heights, wherein there is a piano bench height and a bar stool height.

17. The cart with seat of claim 16, wherein the piano bench height is between about 17 inches and about 19 inches, and wherein the bar stool height is between about 25 inches and about 26 inches.

18. The cart with seat of claim 17, wherein the piano bench height is about 18 inches, and wherein the bar stool height is about 25 inches.

19. The cart with seat of claim 18, wherein the apertures are separated by a distance of between about two and three-quarters inches to about two and one-half inches.

20. The cart with seat of claim 19, wherein the front frame having a third horizontal member, wherein the back frame having a fourth horizontal member, wherein the seat having a forward edge and a rear edge, and wherein the forward edge is removably attached to the third horizontal member and the rear edge is removably attached to the fourth horizontal member.
